(19) United States
(12) Patent Application Publication
(10) Pub. No.: US 2004/0218694 A1
(43) Pub. Date: Nov. 4, 2004

(54) Receiver

(75) Inventor: Paul A. Denny, Bristol (GB)

Correspondence Address: LAHIVE & COCKFIELD, LLP., 28 STATE STREET, BOSTON, MA, 02109, US

(73) Assignee: Phyworks Limited, Bristol (GB)

(21) Appl. No.: 10/442,824

(22) Filed: May 20, 2003

(30) Foreign Application Priority Data
May 1, 2003 (GB) 0310047.6

(51) Int. Cl. H04L 25/06

(52) U.S. Cl. 375/317

(57) ABSTRACT

A method is provided for determining a slice level in the quantizer of a receiver, by determining the proportions of received signal values which lie below and above specified values. These proportions, which correspond to points on a cumulative probability function, can be used with assumptions about the received signal distribution, to determine a desired slice level.

This invention relates to a receiver, and in particular to a receiver for use in an optical communications system.

In an optical communications system, binary signals are transmitted over an optical communications medium, and the function of the receiver is to recreate as far as possible the transmitted sequence of signals.

A sequence of binary values is presented to the transmitter, and a laser light source is switched between two different light intensities, to represent the two different binary values. In the receiver, the instantaneous current output from a photo-detector is proportional to the light incident upon it. An electronic signal is then proportional to the photo-detector output current.

A quantizer compares the signal level with a reference level (the “slice level”) to convert the continuous-valued waveform to a binary valued waveform. The binary valued waveform is time sampled to arrive at a binary sequence, which is intended to be identical to the sequence presented to the transmitter. A very small proportion of errors may occur due to noise introduced by optical amplifiers, by the photo-detector, and by the receiver amplifiers.

A characteristic of noise introduced by an optical amplifier, and by an avalanche photo-detector, is that its power increases with optical signal power. That is, it is non-symmetrical. Where a logic ‘1’ is represented by a larger optical signal intensity than a logic ‘0’, the corresponding noise distribution is larger for transmitted ‘1’s than for transmitted ‘0’s. The distribution of the values of the received continuous-valued waveform, at the centre of each bit period, can be approximated by the sum of a pair of Gaussian distributions, with their means at the two nominal signal levels, and with different standard deviations.

To recover a bit sequence with near minimum number of errors (with respect to the transmitted bit sequence), the slice level must be correctly chosen. With the slice level set correctly, a receiver may deliver a bit error rate of lower than 10⁻¹², but, with the slice level set incorrectly, the error rate may be degraded by several orders of magnitude.

For symmetrical noise, the optimum slice level is exactly half way between the two nominal signal levels. However, in the case of non-symmetrical noise, in which the variances of the sample distributions associated with transmitted ‘0’s and transmitted ‘1’s differ, more sophistication is necessary to establish a suitable slice-level.

One commonly used method to determine the slice level, for near-optimum performance in the presence of non-symmetrical noise distributions, involves a set-up procedure. In this known procedure, a pre-defined pseudo-random bit sequence is transmitted, and several error rate measurements are made with different slice levels. Since a correctly set slice level can produce an error rate of lower than 10⁻¹², as mentioned above, it would be too time-consuming to make meaningful error rate measurements using slice levels close to the optimum slice level. Therefore, firstly, error rate measurements are made with several different slice levels which are all significantly towards the nominal ‘0’ value. The resulting errors are dominated by transmitted ‘0’s which are wrongly determined to be ‘1’s. The error rate can then be plotted against the slice level, and it is found to be a straight line on a log-log plot. Next, error rate measurements are made with several different slice levels which are all significantly towards the nominal ‘1’ value. The resulting errors are dominated by transmitted ‘1’s which are wrongly determined to be ‘0’s. Again, the error rate can be plotted against the slice level, and found to be a straight line on a log-log plot. These two lines can then be extrapolated to find the slice level at which they cross. This procedure attempts to determine the slice level for which the number of errored ‘0’s is equal to the number of errored ‘1’s, which is an acceptable near-optimum slice level.

However, this has the disadvantage that a specific set-up procedure is required, using a known data sequence.

The present invention relates to a method for finding a near-optimum slice level, using live received data.

According to a first aspect of the present invention, there is provided a method of determining a slice level, by determining the proportions of received signal values which lie below and above specified values. These proportions, which correspond to points on a cumulative probability function, can be used with assumptions about the received signal distribution, to determine a desired slice level.

According to a second aspect of the present invention, there is provided a receiver operating in accordance with the method of the first aspect of the invention.

### BRIEF DESCRIPTION OF DRAWINGS

FIG. 1 is a block schematic diagram of a communications system incorporating a receiver in accordance with an aspect of the invention.

FIG. 2 shows a probability density function for received signals.

FIG. 3 shows a cumulative probability function for received signals.

FIG. 4 shows a part of the cumulative probability function, modified.

FIG. 5 is a flow chart, illustrating a method in accordance with the present invention.

### DETAILED DESCRIPTION OF PREFERRED EMBODIMENTS

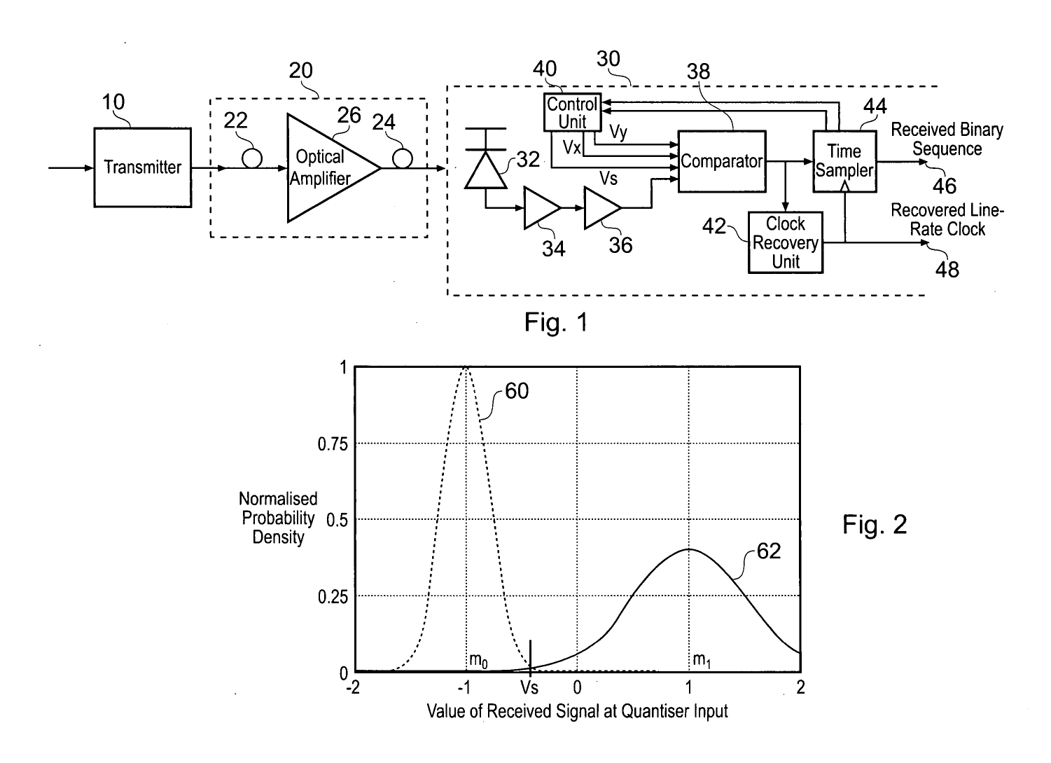

FIG. 1 is a block schematic diagram of a communications system, comprising a transmitter 10, an optical communications medium 20, and a receiver 30.

The transmitter 10 is generally conventional, and will not be described in detail herein. A sequence of binary values is presented to the transmitter, and a laser light source is switched between two different light intensities, to represent the two different binary values.

The optical communications medium 20 is similarly generally conventional, and will not be described in detail herein. However, the optical communications medium 20 includes first and second optical fibre cables 22, 24, with an optical amplifier 26 connected between them to boost the signal level.

In the receiver 30, the laser light output from the second optical fibre cable 24 is incident upon an avalanche photo-detector 32, and the instantaneous current output from the photo-detector 32 is proportional to the light incident upon it.

The current output from the photo-detector 32 is supplied to a transimpedance pre-amplifier 34, and then to a post-amplifier 36, which delivers an output voltage proportional to the photo-detector output current, and therefore proportional to the instantaneous received light power.

The amplified voltage signal is applied to one input of a comparator 38, which acts a quantizer. The second input of the comparator 38 receives a voltage at a reference level Vs (the “slice level”) from a control unit 40. The function of the quantizer is then to compare the instantaneous voltage at the output of the post-amplifier 36 with the slice level, to convert the continuous-valued input voltage waveform to a binary-valued output waveform. That is, the binary-valued output waveform takes a first high value when the instantaneous voltage at the output of the post-amplifier 36 is greater than the slice level, and takes a second low value when the instantaneous voltage at the output of the post-amplifier 36 is less than the slice level.

The binary valued waveform is supplied to a clock recovery unit 42, which generates a clock signal at the frequency of the transmitted data. The binary valued waveform is also supplied to a time sampler, which also receives the recovered clock signal from the clock recovery unit 42. The sampled binary sequence is supplied to the circuit output 46, and can be used for further processing, while the recovered clock signal is supplied to the circuit clock output 48. The sampled binary sequence at the circuit output 46 is intended to be identical to the sequence presented to the transmitter, and the phase of the recovered clock signal time can be adjusted to minimise the number of errors. For example, the phase of the recovered clock signal time can be adjusted such that the time sampler 44 samples the binary waveform at times corresponding to the centre of each bit.

It should also be noted that the receiver 30 may include an equalizer function before the quantizer 38. As described so far, the receiver 30 is generally conventional. However, in this illustrated embodiment of the invention, the comparator block 38 compares the instantaneous voltage at the output of the post-amplifier 36 not only with the slice level Vs, but also with two other reference levels Vx and Vy. The reference levels Vx and Vy are also supplied by the control unit 40. The respective binary-valued waveforms resulting from the comparisons with Vx and Vy are supplied to the time sampler 44 to produce respective sampled binary sequences, which are then fed back to the control unit 40.

The function of the reference levels Vx and Vy, and the control unit 40, will be described in more detail below.

The comparator block 38 may contain separate comparators, for comparing the received signal with the reference levels Vx and Vy at the same time. Alternatively, there may be a single comparator, which compares the received signal with the reference levels Vx and Vy at different times.

Although systems of this general type can be highly accurate, a very small proportion of errors may occur due to noise introduced by optical amplifier 26, by the photo-detector 32, and by the receiver amplifiers 34, 36.

A characteristic of noise introduced by an optical amplifier, and by an avalanche photo-detector, is that the noise power increases with optical signal power. Then, where as here a logic ‘1’ in the transmitted signal is represented by a larger optical signal intensity than a logic ‘0’, there is a greater noise power in the case of transmitted ‘1’s than transmitted ‘0’s.

An acceptable approximation for the probability density function of the value of the received signal level (at the centre of each bit period) is a pair of Gaussian distributions, with their means at the two nominal signal levels, and having different standard deviations. FIG. 2 illustrates the form of this distribution, although it should be recognised that the scales of FIG. 2 are exaggerated, in order to allow easy visual interpretation.

Thus, the overall distribution is made up of a first Gaussian distribution 60, representing the received signal levels relating to transmitted ‘0’s, and a second Gaussian distribution 62, representing the received signal levels relating to transmitted ‘1’s. The first Gaussian distribution 60 has its peak at the nominal received value corresponding to a transmitted ‘0’, and the second Gaussian distribution 62 has its peak at the nominal received value corresponding to a transmitted ‘1’.

Since there are known to be equal numbers of transmitted ‘0’s and transmitted ‘1’s (that is, the transmitted data forms a dc-null code), the areas under the two curves 60, 62 are equal. However, since the noise power added to the signals representing transmitted ‘1’s is greater than the noise power added to the signals representing transmitted ‘0’s, the peak of the curve 62 is lower than the peak of the curve 60, and the variance (or standard distribution) of the distribution 62 is greater than that of the distribution 60.

It should also be noted that the receiver 30 cannot directly derive the form of the separate distributions 60, 62.

Within the receiver, the slice level Vs is set at a point between the peaks such that all received signal values greater than Vs are taken to represent transmitted ‘1’s, while all received signal values less than Vs are taken to represent transmitted ‘0’s. Since there is an overlap between the two distributions 60, 62 (although FIG. 2 exaggerates the extent of this overlap) there will be bit errors which result from transmitted ‘0’s generating received signal values at the extreme right-hand end of the distribution 60, and transmitted ‘1’s generating received signal values at the extreme left-hand end of the distribution 62.

With the slice level set optimally, the receiver may deliver a bit error rate of lower than 10⁻¹². However, with the slice level set incorrectly, the error rate may be degraded by several orders of magnitude.

The present invention is therefore concerned with the selection of a slice level Vs which minimises the number of such errors.

As a near-optimum slice level, there is preferably selected a slice level which equalises bit errors resulting from transmitted ‘0’s and transmitted ‘1’s.

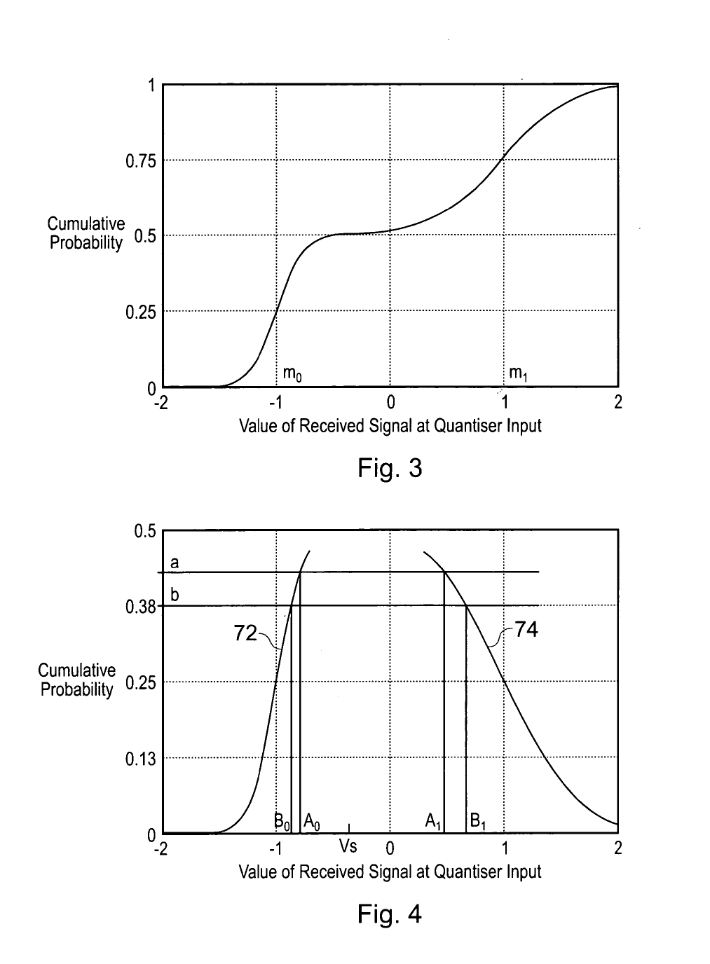

As mentioned above, neither the separate distributions 60, 62 shown in FIG. 2, nor the overall probability density function which is the sum of the distributions 60, 62, are known in the receiver 30. However, FIG. 3 shows the form of function which can be directly derived from measurements made in the receiver 30.

Specifically, FIG. 3 is a cumulative probability function showing, for a range of values, the probability that the received signal falls below that value. The cumulative probability function represents the integral of the overall probability density function.

Thus, by setting one of the reference values Vx, Vy to a particular value, the control unit 40 can determine the proportion of received samples which lie above and below that value. This gives the position of a point on the cumulative probability function shown in FIG. 3.

For values at the low end of the scale, no received values lie below those values. The cumulative probability function increases rapidly with the received signal value for values near the nominal received value corresponding to a transmitted ‘0’, it increases more slowly with the received signal value for values between the nominal values, and it again increases rapidly with the received signal value for values near the nominal received value corresponding to a transmitted ‘1’.

Since 50% of transmitted ‘0’s but effectively no transmitted ‘1’s have values which lie below the nominal received value corresponding to a transmitted ‘0’, this value has a cumulative probability of 25%. Since 50% of transmitted ‘1’s plus effectively all transmitted ‘0’s have values which lie below the nominal received value corresponding to a transmitted ‘1’, this value has a cumulative probability of 75%.

Points on this cumulative probability function can be obtained in the receiver 30 by setting one of the reference values Vx, Vy to a selected received signal value, and counting in the control unit 40 how many received bits in the respective sampled binary sequence lie below and above the reference value.

As mentioned above, the illustrated embodiment of the present invention determines a slice level which equalises bit errors resulting from transmitted ‘0’s and transmitted ‘1’s. That is, it selects a slice level which results in equal numbers of transmitted ‘0’s generating received signal values in the tail of the distribution 60 greater than the slice level, and transmitted ‘1’s generating received signal values in the tail of the distribution 62 less than the slice level.

With the distributions 60, 62 assumed to be normal, or Gaussian, the number of values in each of these two tails of the distributions depends on the distance of the slice level from the respective mean, as a multiple of the respective standard deviation.

Thus, if the distribution 60 has a mean m₀ and a standard deviation σ₀, and the distribution 62 has a mean m₁ and a standard deviation σ₁, then the aim is to choose a slice level Vs such that:

(Vs−m₀)/σ₀=(m₁−Vs)/σ₁. (1)

Again, the standard distributions σ₀, σ₁ cannot be derived directly from measurements which can be made in the receiver 30, but can be derived indirectly from the cumulative probability function shown in FIG. 3.

Specifically, the cumulative probability function is used to find a pair of points on the distribution 60, and another pair of points at equivalent positions on the distribution 62.

FIG. 4 shows one part 72 of the cumulative probability function, plus one part 74 of the inverted cumulative probability function. Thus, the curve 72 represents the probability that a received value is less than the value on the horizontal axis, while the curve 74 represents the probability that a received value is greater than the value on the horizontal axis. Two cumulative probabilities a and b are then selected, with the received value on curve 72 corresponding to the cumulative probability a being denoted A₀, the received value on curve 72 corresponding to the cumulative probability b being denoted B₀, the received value on curve 74 corresponding to the cumulative probability a being denoted A₁, and the received value on curve 74 corresponding to the cumulative probability b being denoted B₁.

Then, the ratio of the separations between A₀ and A₁ and their respective means m₀ and m₁, and the ratio of the separations between B₀ and B₁ and their respective means m₀ and m₁, are equal to the ratio of the two respective standard deviations σ₀ and σ₁. That is:

|A₁−m₁|/|A₀−m₀|=σ₁/σ₀=|B₁−m₁/|B₀−m₀|. (2)

Since it is also clear that:

|m₁−Vs|=|A₁−m₁+|Vs−A₁| (3)

and

|m₀−Vs|=|A₀−m₀|+|Vs−A₀|, (4)

equations (1)-(4) can be combined to indicate that the slice level Vs should be chosen such that:

|Vs−A₁|/|A₁−B₁|=|Vs−A₀|/|A₀−B₀|. (5)

This equation can be solved for Vs, using only the parameters A₀, A₁, B₀ and B₁, which can be obtained from the cumulative probability function.

It will also be apparent that Vs can be calculated in other ways, using measurements of cumulative probabilities corresponding to particular received signal values.

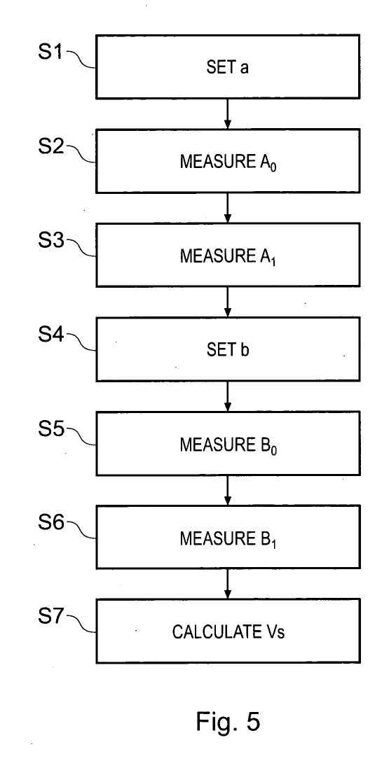

FIG. 5 is a flow chart illustrating the method carried out by the control unit 40, in accordance with the invention, for determining the near-optimum slice level Vs as described above.

Firstly, in step S1, a cumulative probability value a is set, and then in step S2 one of the reference values Vx, Vy is adjusted to find the value A₀ which produces a probability a that the received signal value is less than A₀. In step S3, the other reference value is adjusted to find the value A₁ which produces the same probability a that the received signal value is more than A₁.

Then, in step S4, a second cumulative probability value b is set, and then in step S5 one of the reference values Vx, Vy is adjusted to find the value B₀ which produces a probability b that the received signal value is less than B₀. In step S6, the other reference value is adjusted to find the value B₁ which produces the same probability b that the received signal value is more than B₁.

Finally, in step S7, the value of the slice level Vs is calculated using equation (5) above. The control unit 40, having calculated the required slice level, can then set the appropriate for Vs as an input to the comparator 38.

In principle, any values can be chosen for the first and second cumulative probabilities a and b. However, the accuracy of the calculation can be increased by maximising as far as reasonable the separations (A₁−B₁) and (A₀−B₀), since these terms appear in equation (5). Also, it is preferable to choose values for the first and second cumulative probabilities a and b which are spaced from 0.5, since it is necessary to choose points at which the overall distribution is dominated by one or other of the distributions 60, 62, in order that the shape of the distribution is as close as possible to Gaussian at those points. Against that, however, it should be noted that the amplifiers 34, 36 are optimised for accuracy in the measurement of received values near the centre of the possible range, since this is where the most accurate quantization decisions are required. The amplifiers 34, 36 may be somewhat non-linear for more extreme received signal values. It is therefore preferred to select cumulative probabilities a and b which are in the range of 0.25-0.45, preferably 0.35-0.45.

Depending on the accuracy with which the reference values Vx, Vy may be adjusted, it may not be possible to set reference values which produce exactly the desired cumulative probabilities. In that case, values for A₀, A₁, B₀ and B₁ may be obtained by interpolating or extrapolating from points on the cumulative probability curve.

As mentioned above, this analysis assumes that the data is transmitted using a dc-null code, with equal numbers of transmitted ‘0’s and ‘1’s. However, the same technique can be used, with appropriate adjustments to the equations used, when the numbers of transmitted ‘0’s and ‘1’s are not equal, provided that the proportions of transmitted ‘0’s and ‘1’s are known.

1. A method of calculating a desired slice level for a quantizer in a receiver, the method comprising:
detecting received signals having received signal values, the received signal values having an overall distribution which is the sum of a first distribution representing transmitted binary ‘0’s and a second distribution representing transmitted binary ‘1’s;
determining a first received signal level, A₀, such that the proportion of received signal values lying below the first received signal level is equal to a first probability value (a);
determining a second received signal level, A₁, such that the proportion of received signal values lying above the second received signal level is equal to the first probability value (a);
determining a third received signal level, B₀, such that the proportion of received signal values lying below the third received signal level is equal to a second probability value (b);
determining a fourth received signal level, B₁, such that the proportion of received signal values lying above the fourth received signal level is equal to the second probability value (b); and
calculating the desired slice level from the first, second, third and fourth received signal levels.

2. A method as claimed in claim 1, comprising setting the first and second probability values such that the first and third received signal levels lie in a region of the overall distribution which is dominated by the first Gaussian distribution, and the second and fourth received signal levels lie in a region of the overall distribution which is dominated by the second Gaussian distribution.

3. A method as claimed in claim 1, comprising calculating the desired slice level such that the number of errors resulting from transmitted binary ‘0’s can be taken to be equal to the number of errors resulting from transmitted binary ‘1’s.

4. A method as claimed in claim 3, wherein the first distribution can be approximated as a first Gaussian distribution having a first mean m₀ and a first standard deviation σ₀, and the second distribution can be approximated as a second Gaussian distribution having a second mean m₁ and a second standard deviation σ₁, the method comprising setting a slice level Vs such that:
(Vs−m₀)/σ₀=(m₁−Vs)/σ₁.

5. A method as claimed in claim 4, wherein the slice level is set using the property that the ratio of the separations between the first received signal level A₀ and the second received signal level A₁ and the respective first and second means m₀ and m₁, and the ratio of the separations between the third received signal level B₀ and the fourth received signal level B₁ and their respective first and second means m₀ and m₁, are equal to the ratio of the respective first and second standard deviations σ₀ and σ₁.

6. A method of calculating a desired slice level for a quantizer in a receiver, the method comprising:
detecting received signal values, the received signal values having an overall probability density distribution which can be approximated by the sum of a first Gaussian distribution representing transmitted binary ‘0’s and a second Gaussian distribution representing transmitted binary ‘1’s, and having a cumulative probability function which is the integral of the overall probability density distribution;
determining points on the cumulative probability function, in regions in which the overall probability density distribution is dominated by the first Gaussian distribution and by the second Gaussian distribution respectively;
calculating the desired slice level from the points on the cumulative probability function.

7. A method as claimed in claim 6, comprising determining two points on the cumulative probability function in a region in which the overall probability density distribution is dominated by the first Gaussian distribution, and determining two points on the cumulative probability function in a region in which the overall probability density distribution is dominated by the second Gaussian distribution.

8. A method of calculating a desired slice level for a quantizer in a receiver, the method comprising:
detecting received signals, the received signals lying within a range which includes a first signal level corresponding to a nominal signal level for transmitted binary ‘0’s and a second signal level corresponding to a nominal signal level for transmitted binary ‘0’s;
for a plurality of signal levels within said range:
determining the respective proportions of received signal lying below and above the signal levels; and
calculating the desired slice level from the determined respective proportions.

9. A receiver, for detecting received signal values, the received signal values having an overall distribution which is the sum of a first distribution representing transmitted binary ‘0’s and a second distribution representing transmitted binary ‘1’s, the receiver comprising a quantizer, and being adapted to calculate a desired slice level for the quantizer, the receiver further comprising:
a control unit and at least one comparator, for:
determining a first received signal level, A₀, such that the proportion of received signal values lying below the first received signal level is equal to a first probability value (a);
determining a second received signal level, A₁, such that the proportion of received signal values lying above the second received signal level is equal to the first probability value (a);
determining a third received signal level, B₀, such that the proportion of received signal values lying below the third received signal level is equal to a second probability value (b);
determining a fourth received signal level, B₁, such that the proportion of received signal values lying above the fourth received signal level is equal to the second probability value (b); and
calculating the desired slice level from the first, second, third and fourth received signal levels.

10. A receiver as claimed in claim 9, further comprising an additional comparator, for comparing received signal values with a slice level.
